(19) United States
(12) Patent Application Publication
(10) Pub. No.: US 2007/0132997 A1
(43) Pub. Date: Jun. 14, 2007

(54) Device and method for examining and calibrating color temperature

(75) Inventor: Shu-Wen Chuang, Taipei (TW)

Correspondence Address: REED SMITH LLP, Suite 1400, 3110 Fairview Park Drive, Falls Church, VA, 22042, US

(73) Assignee: Inventec Corporation

(21) Appl. No.: 11/634,987

(22) Filed: Dec. 7, 2006

(30) Foreign Application Priority Data
Dec. 9, 2005 (TW) 094143664

(51) Int. Cl. G01J 3/46

(52) U.S. Cl. 356/402; 356/425

(57) ABSTRACT

A device and method for examining and calibrating color temperature are provided for a color temperature examination/calibration station in a display product line. The color temperature examination/calibration station has a signal generator and a collection device. The signal generator is used to provide signals to the display, such that to carry out the color temperature can be examined and calibrated without inputting signals to the display by a computer system. The collection device is used to connect a plurality of displays with color temperatures to be calibrated to a computer system, such that the color temperatures of the plurality of displays can be examined and calibrated by the computer system at the same time.

### CROSS-REFERENCE TO RELATED APPLICATIONS

This non-provisional application claims priority under 35 U.S.C. § 119(a) on Patent Application No(s). 094143664 filed in Taiwan, R.O.C. on Dec. 9, 2005, the entire contents of which are hereby incorporated by reference.

### BACKGROUND OF THE INVENTION

1. Field of Invention

The present invention relates to a device and method for examining and calibrating color temperature, applied to a color temperature examination/calibration station in a display product line, for examining and calibrating color temperature of displays.

2. Related Art

At present, an OSD (On Screen Display) of a display contains a color temperature option, for users to select different color temperature values according to individual preference. Display manufacturers should adopt an automatic color temperature calibration process to control the calibration of the display color temperature, thus achieving a uniform color temperature of all finished display products. A conventional automatic color temperature calibration process, wherein the device and method are adopted to prevent color temperature deviation caused by manual calibration, thereby improving the quality of display manufacture. The device disclosed in the prior art includes a display, a computer system, a color temperature sensing device, and a signal connection line, thus forming a circulation system. An adjuster uses a signal connection line to connect the display and the computer system. The computer system provides signals to the display for displaying pictures. The color temperature sensing device senses a color temperature value when close to the display, and then transmits the sensed color temperature value to the computer system, for carrying out a color temperature value comparison by means of the computer system.

Another prior art, in which a signal generator with wireless transmission function is connected to the display, and a transceiver is connected to the computer system. The display is connected to the computer system by means of wireless transmission, thus there is no need to plug in/pull out the signal connection line during calibration. The connecting method for wireless transmitting signals between the signal generator of the display and the transceiver of the computer system includes that when the display arrives the color temperature calibration station, the transceiver of the computer system senses the signals output by the signal generator of the display. When the signal connection between the display and the computer system succeeds, i.e., it is confirmed that the display has reached the location, a program control of the computer system is used to implement the display color temperature calibration process.

The conventional display calibration method, when used in practical calibration, has the following shortcomings or improvement.

According to the prior art, a color temperature calibration process is approximately divided into four stages, namely, connecting the computer system and the display (first stage); controlling the display by means of the computer system (second stage); performing color temperature sensing by means of the color temperature sensing device (third stage:); and performing color temperature comparison by means of the computer system (fourth stage).

In the first stage of the prior art, a wireless transmission connection is employed to replace the wired transmission connection, thus reducing the time required for connecting the computer system and the display in the first stage. The object of the second stage is to make the display show a picture for sensing under the control of the computer system. However, the same object can be achieved by other methods, i.e., the display can show a picture without the control of a computer, wherein the color temperature sensing can be directly carried out after the display is positioned at the color temperature calibration station, thereby saving a process of controlling by the computer system.

In the prior art, a single computer system is adopted to adjust the color temperature of a single display during the color temperature calibration. However, the color temperature calibration method fails to exert the function when applied in a computer system of mass calculation function, and has a negative effect on the overall production efficiency of the display.

### SUMMARY OF THE INVENTION

In order to solve the above problem, the present invention provides a display color temperature examination/calibration device and method, for improving the efficiency of color temperature examination/calibration in the display product line.

Therefore, to achieve the above object, the device for automatically calibrating the display color temperature provided by the invention includes a computer system, a color temperature sensor, a color analyzer, a display, a collection device, and a signal generator. The technical measure for applying the device employs a signal generator respectively connected to each display for providing signals to the display to form a picture. The object of connecting a signal generator lies in that the display color temperature calibration can be started without inputting signals to the display via the computer system to perform the color temperature examination/calibration operation.

During the color temperature examination, a plurality of color temperature sensors are disposed in the front of the corresponding displays, for simultaneously sensing the color temperatures of the plurality of displays. The color temperature detectors are all connected to the collection device and the collection device is further connected to the computer system. Therefore, the object of connecting a collection device lies in that the computer system can be connected simultaneously to a plurality of color temperature sensors via the collection device, thereby examing the color temperature for a plurality of displays simultaneously. In view of the above, the device and method disclosed in the present invention are used to improve the efficiency of the display color temperature examination and calibration.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a schematic view of a display color temperature examination/calibration device according to a first preferred embodiment of the invention;

FIG. 2 is a schematic view of a display color temperature examination/calibration device according to a second embodiment of the invention;

FIG. 3 is a schematic view of a display color temperature examination/calibration device according to a third embodiment of the invention; and

FIG. 4 is a schematic view of a display color temperature examination/calibration device according to a fourth embodiment of the invention.

### DETAILED DESCRIPTION OF THE INVENTION

The detailed features and advantages of the invention are described in detail in the following embodiments. Anybody skilled in the related arts can easily understand and implement the technology content of the invention. Furthermore, the relative objects and advantages of the invention are apparent to those skilled in the related arts according to the content disclosed in the specification, claims, and drawings.

The present invention provides four embodiments, and each of them may be implemented by display manufacturers.

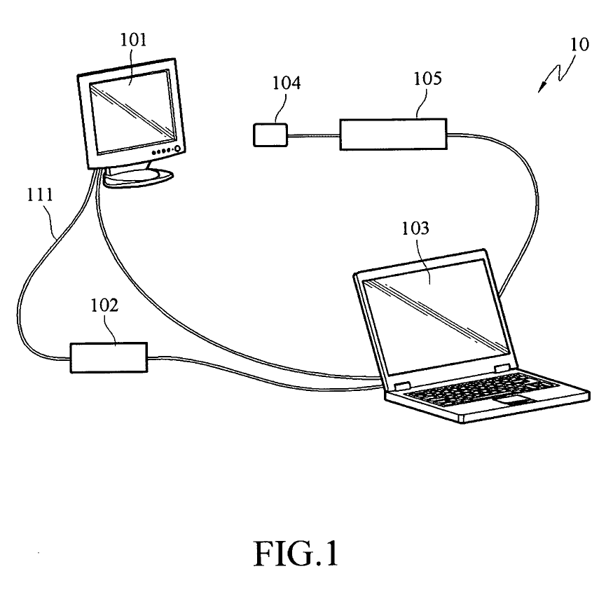

With respect to the first embodiment, referring to FIG. 1, a display 101 is connected to a signal generator 102 on the conveyor belt of the product line. The display 101 is connected to the signal generator 102 via a wired transmission interface 111. The wired transmission interface 111 can be divided into a PC interface and an AV interface, wherein the PC interface is a digital visual interface (DVI), a D-subminiature (D-sub), a high-definition multimedia interface (HDMI), or the like, while the AV interface is a composite video broadcast signal (CVBS), an S-video, or the like.

A color temperature examination/calibration station 10 has a computer system 103, a color temperature sensor 104, and a color analyzer 105. The color temperature sensor 104 is connected to the color analyzer 105. The color analyzer 105 is connected to the computer system 103. The computer system 103 is further respectively connected to the display 101 and the signal generator 102 by means of a wired connection.

After the display 101 is conveyed to the color temperature examination/calibration station 10 by the conveyor belt of the product line and positioned, the display 101 begins to accept color temperature examination. The color temperature examination mode of the display 101 can be divided into a PC mode and an AV mode. If the PC mode is examined first, the signal generator 102 provides image signals to the display 101 via the PC interface for displaying an image. The color temperature sensor 104 senses the color temperature generated by the image. The color analyzer 105 analyzes the color temperature to obtain a color temperature value, and sends the color temperature value to the computer system 103 for color temperature comparison. The computer system 103 compares the sensed color temperature value with the predetermined one, resulting in different color temperature calibrating sequences according to the comparison result, i.e., whether both values are consistent or not.

If consistent, it proceeds to examine another color temperature, until color temperature examination and calibration of the PC interface under the PC mode are completed. Then, the color temperature examination and calibration of the AV mode are performed. Under the AV mode, the signal generator 102 provides image signals to the display 101 via the AV interface, for performing the color temperature examination and calibration, until color temperature examination and calibration of the AV interface under the AV mode are completed. Thus, the color temperature examination/calibration process of the display 101 is finished.

If not consistent, color temperature calibration of the display 101 is carried out. The computer system 103 transmits the color temperature correction value to the display 101, and the display 101 corrects the color temperature of the displayed image and displays the corrected image. The corrected image is subjected to color temperature comparison again until the color temperature comparison shows consistency.

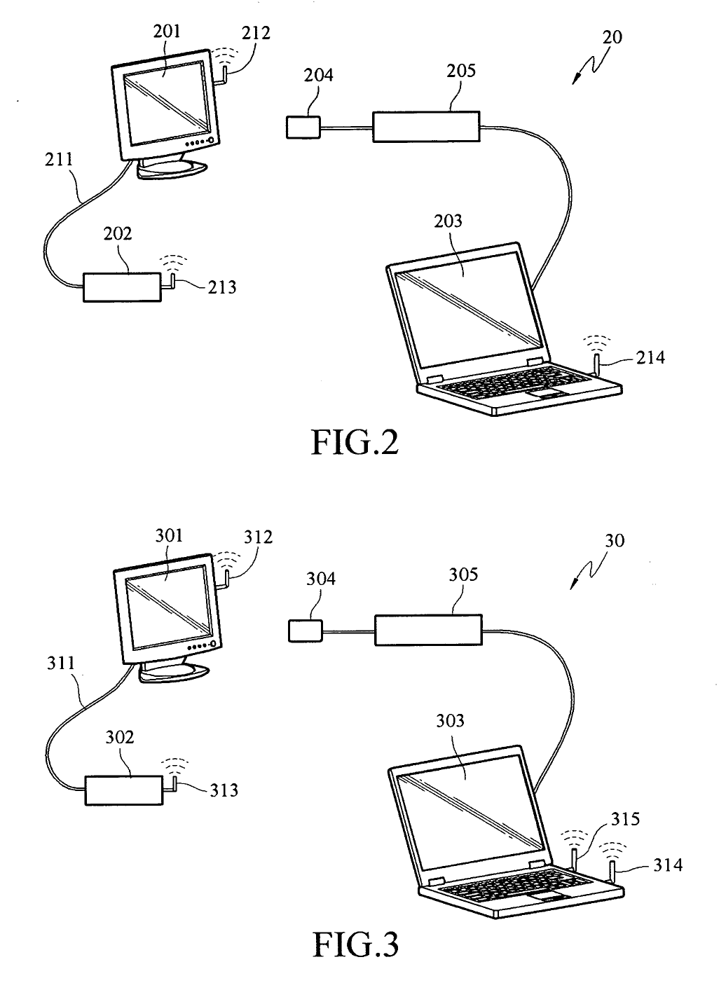

With respect to the second embodiment, referring to FIG. 2, a display 201 is connected to a signal generator 202 on the conveyor belt of the product line. The display 201 is connected to the signal generator 202 via a wired transmission interface 211. The wired transmission interface 211 is divided into a PC interface and an AV interface. The PC interface can be a DVI, a D-sub, an HDMI, or the like, while the AV interface can be a CVBS, an S-video, or the like. Moreover, a first wireless transceiver 212 is disposed on the display 201, and a second wireless transceiver 213 is disposed on the signal generator 202.

The color temperature examination/calibration station 20 has a computer system 203, a color temperature sensor 204, and a color analyzer 205. The color temperature sensor 204 is connected to the color analyzer 205. The color analyzer 205 is connected to the computer system 203. A third wireless transceiver 214 is disposed on the computer system 203. The computer system 203 is respectively connected to the first transceiver 212 of the display 201 and the second wireless transceiver 213 of the signal generator 202 via the third wireless transceiver 214. The wireless transmitting/receiving frequency of the third wireless transceiver 214 and the first wireless transceiver 212 is f1, and the wireless transmitting/receiving frequency of the third wireless transceiver 214 and the second wireless transceiver 213 is f2.

After the display 201 is conveyed to the color temperature examination/calibration station 20 by the conveyor belt of the product line and positioned, the display 201 begins to accept color temperature examination. The color temperature examination mode of the display 201 is divided into a PC mode and an AV mode. If the PC mode is checked first, the signal generator 202 provides image signals to the display 201 via the PC interface for displaying an image. The color temperature sensor 204 senses the color temperature generated by the image. The color analyzer 205 analyzes the color temperature to obtain a color temperature value, and sends the color temperature value to the computer system 203 for color temperature comparison. The computer system 203 compares the sensed color temperature value with the predetermined one, resulting in different color temperature calibrating sequences according to the comparison result, i.e., whether both values are consistent or not.

If consistent, it proceeds to examine another color temperature until color temperature examination and calibration of the PC interface under the PC mode are completed. Then, the color temperature examination and calibration of the AV mode are performed. The computer system 203 transmits a control signal to the signal generator 202 via the third wireless transceiver 214. The control signal is received by the second wireless transceiver 213, making the signal generating device 202 provide image signals to the display 201 for displaying. Under the AV mode, the signal generator 202 provides image signals to the display 201 via the AV interface for carrying out the color temperature examination and calibration, until color temperature examination and calibration of the AV interface under the AV mode are completed. Thus, the color temperature examination/calibration process of the display 201 is finished.

If not consistent, color temperature calibration of the display 201 is carried out. The computer system 203 transmits the color temperature correction value to the display 201 via the third wireless transceiver 214. The color temperature correction value is received by the first wireless transceiver 212. The display 201 corrects the color temperature of the displayed image and displays the corrected image. The corrected image is subjected to color temperature comparison again until the color temperature comparison shows consistency. Thus, the process is finished.

With respect to the third embodiment, referring to FIG. 3, a display 301 is connected to a signal generator 302 on the conveyor belt of the product line. The display 301 is connected to the signal generator 302 via a wired transmission interface 311. The wired transmission interface 311 is divided into a PC interface and an AV interface. The PC interface can be a DVI, a D-sub, an HDMI, or the like, while the AV interface is a CVBS, an S-video, or the like. Moreover, a first wireless transceiver 312 is disposed on the display 301, and a second wireless transceiver 313 is disposed on the signal generator 302.

The color temperature examination/calibration station 30 has a computer system 303, a color temperature sensor 304, and a color analyzer 305. The color temperature sensor 304 is connected to the color analyzer 305. The color analyzer 305 is connected to the computer system 303. A third wireless transceiver 314 and a fourth wireless transceiver 315 are disposed on the computer system 303. The computer system 303 is connected to the first wireless transceiver 312 of the display 301 via the third wireless transceiver 314, and is connected to the second wireless transceiver 313 of the signal generator 302 via the fourth wireless transceiver 315. The wireless transmitting/receiving frequency of the third wireless transceiver 314 and the first wireless transceiver 312 is f1, while the wireless transmitting/receiving frequency of the fourth wireless transceiver 315 and the second wireless transceiver 313 is f2.

After the display 301 is conveyed to the color temperature examination/calibration station 30 by the conveyor belt of the product line and positioned, the display 301 begins to accept color temperature checking. The color temperature examination mode of the display 301 is divided into a PC mode and an AV mode. If the PC mode is examined first, the signal generator 302 provides image signals to the display 301 via the PC interface for displaying an image. The color temperature sensor 304 senses the color temperature generated by the image. The color analyzer 305 analyzes the color temperature to obtain a color temperature value, and sends the color temperature value to the computer system 303 for color temperature comparison. The computer system 303 compares the sensed color temperature value with the predetermined one, resulting in different color temperature calibrating sequences according to the comparison result, i.e., whether both values are consistent or not.

If consistent, it proceeds to examine another color temperature. The computer system 303 transmits a control signal to the second wireless transceiver 313 of the signal generator 302 via the fourth wireless transceiver 315, so as to display another image and continue completing color temperature examination and calibration, until all color temperature examination and calibration of the PC interface under the PC mode are completed. Then, color temperature examination and calibration of the AV mode is carried out. Under the AV mode, the signal generator 302 provides image signals to the display 301 via the AV interface, and the computer system 303 transmits control signals to the second wireless transceiver 313 of the signal generator 302 via the fourth wireless transceiver 315, for carrying out the color temperature examination and calibration, until all color temperature examination and calibration of the AV interface under the AV mode are completed. Thus, the color temperature examination/calibration process of the display 301 is finished.

If not consistent, the color temperature calibration of the display 301 is carried out. The computer system 303 transmits the color temperature correction value to the display 301 via the third wireless transceiver 314. The color temperature correction value is received by the first wireless transceiver 312. The display 301 corrects the color temperature of the displayed image and displays the corrected image. The corrected image is subjected to the color temperature comparison again until the color temperature comparison shows consistency. Thus, the process is finished.

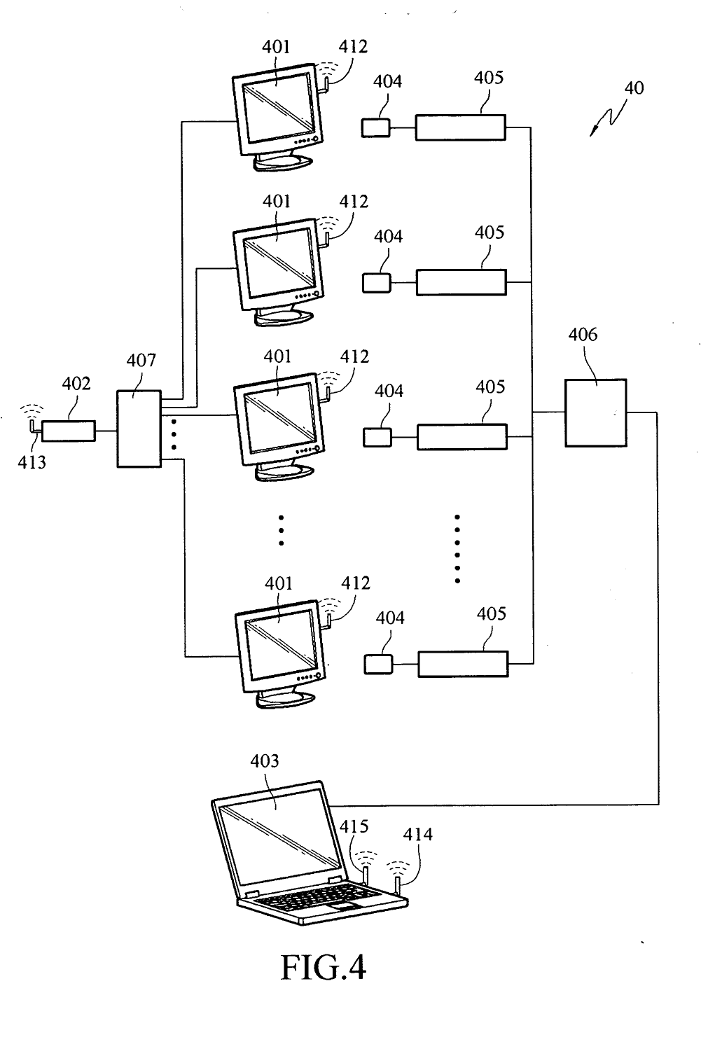

With respect to the fourth embodiment, referring to FIG. 4, a plurality of displays 401 is disposed on the conveyor belt of the product line. A signal generator 402 is connected to a signal distribution device 407. Each of the displays 401 is connected to the signal distribution device 407 via a wired transmission interface 411. The wired transmission interface 411 is divided into a PC interface and an AV interface. The PC interface can be a DVI, a D-sub, an HDMI, or the like, while the AV interface can be a CVBS, an S-video, or the like. A first wireless transceiver 412 is disposed on each of the displays 401, and a second wireless transceiver 413 is disposed on the signal generator 402.

The color temperature examination/calibration station 40 has a computer system 403, a plurality of color temperature sensors 404, a plurality of color analyzers 405, and a collection device 406. The color temperature sensors 404 are respectively connected to the color analyzers 405. The color analyzers 405 are gathered at the collection device 406. The collection device 406 is further connected to the computer system 403. A third wireless transceiver 414 and a fourth wireless transceiver 415 are disposed on the computer system 403. The computer system 403 is connected to the first wireless transceiver 412 of each display 401 via the third wireless transceiver 414. Each of the first wireless transceivers 412 respectively has an identification for the computer system 403 to identify. The computer system 403 is further connected to the second wireless transceiver 413 of the signal generator 402 via the fourth wireless transceiver 415. The wireless transmitting/receiving frequency of the third wireless transceiver 414 and the first wireless transceiver 412 is f1, while the transmitting/receiving frequency of the fourth wireless transceiver 415 and the second wireless transceiver 413 is f2.

After each display 401 is conveyed to the color temperature examination/calibration station 40 via the conveyor belt of the product line and positioned, each display 401 begins to accept color temperature examination. The color temperature examination mode of the display 401 is divided into a PC mode and an AV mode. If the PC mode is examined first, the signal generator 402 provides image signals to its corresponding display 401 via the PC interface for displaying an image. Each color temperature sensors 404 senses the color temperature generated by the corresponding display 401. Each color analyzer 405 analyzes the color temperature to obtain a color temperature value, and respectively sends the color temperature value to the collection device 406. The collection device 406 then transmits the color temperature values to the computer system 403 for carrying out multiple color temperature comparisons at the same time. The computer system 403 compares multiple sensed color temperature values with the predetermined one, resulting in different color temperature calibrating sequences according to the comparison result, i.e., whether both values are consistent or not.

If consistent, proceed to examine another color temperature, until color temperature examination and calibration of the PC interface under the PC mode are completed. Then, the color temperature examination and calibration of AV mode is implemented. Under the AV mode, the signal generator 402 provides image signals to the display 401 via the AV interface for performing the color temperature examination and calibration, until all the color temperature examination and calibration of the AV interface under the AV mode are completed. Thus, the color temperature examination/calibration processes of the PC mode and the AV mode of each display 401 are completed, i.e., the color temperature examination/calibration process of the display 401 is finished.

If not consistent, color temperature calibration of the display 401 is carried out. The computer system 403 transmits the color temperature correction value to the display 401 via the third wireless transceiver 414. The color temperature correction value is received by the first wireless transceiver 412. The display 401 corrects the color temperature of the displayed image and displays the corrected image. The corrected image is subjected to the color temperature comparison again until the color temperature comparison shows consistency. Afterward, another color temperature examination of the PC interface is carried out until all color temperature examination and calibration of the PC interface under the PC mode are completed. Then, all the color temperature examination and calibration of the AV interface under the AV mode are completed. Thereby, the color temperature examination and calibration of the PC mode and the AV mode of each display 401 are all finished, i.e., the color temperature examination/calibration process of the display 401 is finished.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A color temperature examination/calibration device, for examining and calibrating a color temperature of a display, comprising:
a signal generator, for providing an image signal to the display to display an image, wherein the signal generator is connected to the display via a wired transmission interface;
a color temperature sensor, for sensing the color temperature of the image;
a color analyzer, for analyzing the color temperature and generating a color temperature value, wherein the color analyzer is connected to the color temperature sensor; and
a computer system, for performing the color temperature value comparison and calibrating the color temperature of the image, wherein the computer system is connected to the signal generator, the display, and the color analyzer.

2. The color temperature examination/calibration device according to claim 1, wherein the wired transmission interface is a digital visual interface (DVI), a composite video broadcast signal (CVBS), an S-video, D-subminiature (D-sub) or a high-definition multimedia interface (HDMI).

3. A color temperature examination/calibration device, for examining and calibrating a color temperature of a display, comprising:
a signal generator, for providing an image signal to the display to display an image, wherein the signal generator is connected to the display via a wired transmission interface;
a color temperature sensor, for sensing the color temperature of the image;
a color analyzer, for analyzing the color temperature and generating a color temperature value, wherein the color analyzer is connected to the color temperature sensor;
a computer system, for performing the color temperature value comparison and calibrating the color temperature of the display image, wherein the computer system is connected to the color analyzer;
a first wireless signal transmitting/receiving device, disposed on the display, for wirelessly transmitting/receiving signals;
a second wireless signal transmitting/receiving device, disposed on the signal generator, for wirelessly transmitting/receiving signals; and
a third wireless signal transmitting/receiving device, disposed on the computer system, for wirelessly transmitting/receiving signals, wherein the third wireless signal transmitting/receiving device is respectively connected to the first wireless signal transmitting/receiving device and the second wireless signal transmitting/receiving device.

4. The color temperature examination/calibration device according to claim 3, wherein the wired transmission interface is a DVI, a composite video broadcast signal (CVBS), an S-video, D-subminiature (D-sub) or a high-definition multimedia interface (HDMI).

5. A color temperature examination/calibration device, for examining and calibrating a color temperature of a display, comprising:
a signal generator, for providing an image signal to the display to display an image, wherein the signal generator is connected to the display via a wired transmission interface;
a color temperature sensor, for sensing the color temperature of the image;
a color analyzer, for analyzing color temperature and generating a color temperature value, wherein the color analyzer is connected to the color temperature sensor;
a computer system, for performing the color temperature comparison and calibrating the color temperature of the display image, wherein the computer system is connected to the color analyzer;
a first wireless signal transmitting/receiving device, disposed on the display, for wirelessly transmitting/receiving signals;
a second wireless signal transmitting/receiving device, disposed on the signal generator, for wirelessly transmitting/receiving signals;
a third wireless signal transmitting/receiving device, disposed on the computer system, for wirelessly transmitting/receiving signals, wherein the third wireless signal transmitting/receiving device is connected to the first wireless signal transmitting/receiving device; and
a fourth wireless signal transmitting/receiving device, disposed on the computer system, for wirelessly transmitting/receiving signals, wherein the fourth wireless signal transmitting/receiving device is connected to the second wireless signal transmitting/receiving device.

6. The color temperature examination/calibration device according to claim 5, wherein the wired transmission interface is a DVI, a composite video broadcast signal (CVBS), an S-video, D-subminiature (D-sub) or a high-definition multimedia interface (HDMI).

7. A color temperature examination/calibration device, for examining and calibrating color temperatures of multiple displays, comprising:
a signal generator, for providing an image signal;
a signal distribution device, for distributing the image signal to each of the displays to display an image, wherein the signal generator is connected to the signal distribution device;
a plurality of color temperature sensors, for sensing the color temperature of the image;
a plurality of color analyzers, for analyzing the color temperature of each display and generating a plurality of color temperature values, wherein each of the color analyzers is respectively connected to each of the color temperature sensors;
a collection device, for gathering each of the color analyzers;
a computer system, for comparing the plurality of color temperature values and calibrating the image color temperature of the plurality of displays, wherein the computer system is connected to the collection device;
a plurality of first wireless signal transmitting/receiving devices, disposed on the display, for wirelessly transmitting/receiving signals;
a second wireless signal transmitting/receiving device, disposed on the signal generator, for wirelessly transmitting/receiving signals;
a third wireless signal transmitting/receiving device, disposed on the computer system, for wirelessly transmitting/receiving signals, wherein the third wireless signal transmitting/receiving device is connected to the first wireless signal transmitting/receiving device; and
a fourth wireless signal transmitting/receiving device, disposed on the computer system, for wirelessly transmitting/receiving signals, wherein the fourth wireless signal transmitting/receiving device is connected to the second wireless signal transmitting/receiving device.

8. The color temperature examination/calibration device according to claim 7, wherein the wired transmission interface is a DVI, a composite video broadcast signal (CVBS), an S-video, D-subminiature (D-sub) or a high-definition multimedia interface (HDMI).

9. A color temperature examination/calibration method, for examining and calibrating a color temperature of a display, comprising:
generating an image signal by means of a signal generator;
transmitting the image signal to a display by means of the signal generator;
displaying an image by means of the display;
sensing the color temperature of the image by means of a color temperature sensor;
generating a first color temperature sensed value by means of a color analyzer analyzing the color temperature of the image;
transmitting the first color temperature sensed value to a computer system by means of the color analyzer; and
comparing the first color temperature sensed value and a predetermined color temperature value by means of the computer system.

10. The color temperature examination/calibration method according to claim 9, further comprising:
if the first color temperature sensed value is not consistent with the predetermined color temperature value, the color temperature of the display is calibrated by the computer system and a second color temperature sensed value is detected after calibration;
comparing the second color temperature sensed value and the predetermined color temperature value; and
if the second color temperature sensed value is consistent with the predetermined color temperature value, another color temperature of the display is examined and calibrated; and if the second color temperature sensed value is not consistent with the predetermined color temperature value, the color temperature of the display is recalibrated.

11. The color temperature examination/calibration method according to claim 9, further comprising:
if the obtained first color temperature is consistent with the predetermined color temperature value, another color temperature of the display is calibrated.

12. A color temperature examination/calibration method, for examining and calibrating color temperatures of a plurality of displays, comprising:
generating an image signal and transmitting the image signal to a signal distribution device by means of a signal generator;
distributing the image signal to a plurality of displays by means of the signal distribution device;
displaying an image by means of each of the displays respectively;
sensing the color temperature of the image by means of a plurality of color temperature sensors respectively detecting each of the corresponding displays;
generating a plurality of color temperature sensed values by means of a plurality of color analyzers respectively analyzing the color temperatures;
transmitting each of the color temperature sensed values to a collection device by means of each of the color analyzers;
capturing each of the color temperature sensed values by means of a computer system; and
comparing each of the color temperature sensed values with a predetermined color temperature value by means of the computer system.

13. The color temperature examination/calibration method according to claim 12, further comprising:
if at least one of the color temperature sensed values is not consistent with the predetermined color temperature value, the color temperature of the display corresponding to the color temperature sensed value is calibrated by means of the computer system.

14. The color temperature examination/calibration method according to claim 12, further comprising:
if at least one of the color temperature sensed values is consistent with the predetermined color temperature value, another color temperature of the display corresponding to the color temperature sensed value is calibrated.
